(19) United States
(12) Patent Application Publication
(10) Pub. No.: US 2024/0143226 A1
(43) Pub. Date: May 2, 2024

(54) Data storage device and method for managing a write buffer

(71) Applicant: Silicon Motion, Inc., Hsinchu County (TW)

(72) Inventor: Po-Lin Wu, Hsinchu City (TW)

(73) Assignee: Silicon Motion, Inc., Hsinchu County (TW)

(21) Appl. No.: 18/220,293

(22) Filed: Jul. 11, 2023

(30) Foreign Application Priority Data
Oct. 27, 2022 (TW) 111140793

(51) Int. Cl. G06F 3/06

(52) U.S. Cl. CPC G06F 3/0659; G06F 3/0604; G06F 3/0652; G06F 3/0656; G06F 3/0679

(57) ABSTRACT

A data storage device includes a memory device and a memory controller. The memory device includes multiple predetermined memory blocks that are configured as a buffer for receiving data from a host device. The memory controller performs a write operation in response to a write command, and during the write operation, the memory controller maintains a first quantity count value for counting a number of the predetermined memory block(s) that has/have been written with data, determine a number of the predetermined memory block(s) which is/are released in response to the write operation and maintains a second quantity count value based on this number. After the write operation, the memory controller performs a garbage collection and updates the first quantity count value based on the second quantity count value when determining that the host device has requested to perform a flush operation on the predetermined memory blocks.

### BACKGROUND OF THE INVENTION

### 1. Field of the Invention

The invention relates to a method for managing a write buffer, to correctly managing and maintaining parameters related to the write buffer.

### 2. Description of the Prior Art

With the rapid growth of data storage technology in recent years, many data storage devices—such as memory cards manufactured in compliance with the Secure Digital (SD)/Multi Media Card (MMC) standards, Compact Flash (CF) standards, Memory Stick (MS) standards or Extreme Digital (XD) standards, as well as solid state hard drives, Embedded Multi Media Cards (eMMC) and Universal Flash Storage (UFS)—have been used widely for a variety of purposes.

Usually, the data storage device configures a write buffer to receive data from the host. The product developer will perform various write buffer related tests to confirm that the write operation of the data storage device functions normally, and determine whether the data storage device is able to correctly record various parameters related to the write buffer. If the method for parameter maintenance is not well designed, the parameters may be recorded correctly in certain test scenarios, but cannot be recorded correctly in other test scenarios. To solve this problem, a method for managing a write buffer to correctly maintain the parameters related to the write buffer in all test scenarios is required.

### SUMMARY OF THE INVENTION

It is an objective of the invention to provide a method for managing a write buffer to correctly maintain the parameters related to the write buffer.

According to an embodiment of the invention, a data storage device comprises a memory device comprising a plurality of memory blocks which comprise a plurality of predetermined memory blocks that are configured as a buffer for receiving data from a host device and a memory controller coupled to the memory device and configured to access the memory device. The memory controller is configured to perform a write operation in response to a write command issued by the host device. In the write operation, the memory controller is configured to maintain a first quantity count value for counting a number of the predetermined memory block(s) that has/have been written with data, determine a number of the predetermined memory block(s) which is/are released in response to the write operation and maintain a second quantity count value based on the number of the predetermined memory block(s) which is/are released in response to the write operation. After the write operation is completed, the memory controller is further configured to perform a garbage collection operation and determine whether the host device has requested to perform a flush operation on the predetermined memory blocks. When determining that the host device has requested to perform the flush operation on the predetermined memory blocks, the memory controller is further configured to update the first quantity count value based on the second quantity count value.

According to an embodiment of the invention, a method for managing a write buffer of a data storage device which comprises a memory device and a memory controller is proposed. The memory device comprises a plurality of memory blocks which comprise a plurality of predetermined memory blocks that are configured as a buffer for receiving data from a host device. The method comprises performing a write operation in response to a write command issued by the host device; performing a garbage collection operation; determining whether the host device has requested to perform a flush operation on the predetermined memory blocks; and updating a first quantity count value based on a second quantity count value when determining that the host device has requested to perform the flush operation on the predetermined memory blocks. Step of performing the write operation in response to the write command issued by the host device further comprises: maintaining the first quantity count value for counting a number of the predetermined memory block(s) that has/have been written with data; determining a number of the predetermined memory block(s) which is/are released in response to the write operation; and maintaining the second quantity count value based on the number of the predetermined memory block(s) which is/are released in response to the write operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows an exemplary block diagram of a data storage device according to an embodiment of the invention.

FIG. 2 shows a schematic flow chart of the method for managing a write buffer of a data storage device according to a first embodiment of the invention.

FIG. 3 shows a detailed flow chart of the method for managing a write buffer of a data storage device according to the first embodiment of the invention.

FIG. 4 shows a schematic flow chart of the method for managing a write buffer of a data storage device according to a second embodiment of the invention.

FIG. 5 shows a detailed flow chart of the method for managing a write buffer of a data storage device according to the second embodiment of the invention.

### DETAILED DESCRIPTION

In the following, numerous specific details are described to provide a thorough understanding of embodiments of the invention. However, one of skilled in the art will understand how to implement the invention in the absence of one or more specific details, or relying on other methods, elements or materials. In other instances, well-known structures, materials or operations are not shown or described in detail in order to avoid obscuring the main concepts of the invention.

Reference throughout this specification to “one embodiment”, “an embodiment”, “one example” or “an example” means that a particular feature, structure or characteristic described in connection with the embodiment or example is included in at least one embodiment of a plurality of embodiments. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples.

In addition, in order to make the objects, features and advantages of the invention more comprehensible, specific embodiments of the invention are set forth in the accompanying drawings. This description is made for the purpose of illustrating the general principles of the invention and should not be taken in a limiting sense. It should be understood that the following embodiments can be implemented by software, hardware, firmware, or any combination thereof.

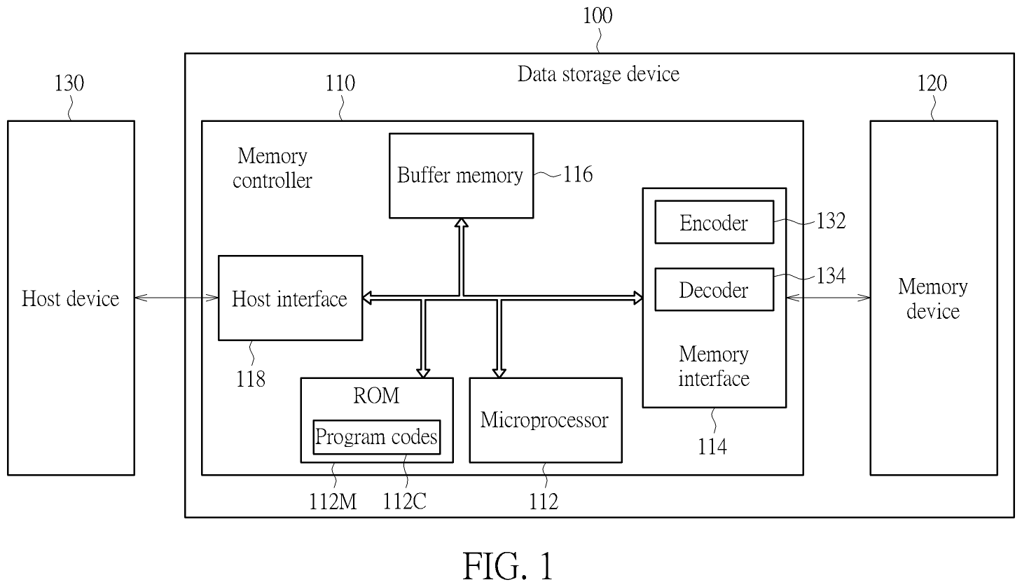

FIG. 1 shows an exemplary block diagram of a data storage device according to an embodiment of the invention. The data storage device 100 may comprise a memory device 120 and a memory controller 110. The memory controller 110 is configured to access the memory device 120 and control operations of the memory device 120. The memory device 120 may be a non-volatile (NV) memory (e.g., a Flash memory) device and may comprise one or more memory elements (e.g., one or more Flash memory dies, or one or more Flash memory chip, or the likes).

The data storage device 100 may be coupled to a host device 130. The host device 130 may comprise at least one processor, a power supply circuit, and at least one random access memory (RAM), such as at least one dynamic RAM (DRAM), at least one static RAM (SRAM), . . . etc. (not shown in FIG. 1). The processor and the RAM may be coupled to each other through a bus, and may be coupled to the power supply circuit to obtain power. The processor may be arranged to control operations of the host device 130, and the power supply circuit may be arranged to provide the processor, the RAM, and the data storage device 100 with power. For example, the power supply circuit may output one or more driving voltages to the data storage device 100. The data storage device 100 may obtain the one or more driving voltages from the host device 130 as the power of the data storage device 100 and provide the host device 130 with storage space.

According to an embodiment of the invention, the memory controller 110 may comprise a microprocessor 112, a Read Only Memory (ROM) 112M, a memory interface 114, a buffer memory 116 and a host interface 118. The ROM 112M is configured to store program codes 112C. The microprocessor 112 is configured to execute the program codes 112C, thereby controlling access to the memory device 120. The program codes 112C may comprise one or more program modules, such as the boot loader code. When the data storage device 100 obtains power from the host device 130, the microprocessor 112 may perform an initialization procedure of the data storage device 100 by executing the program codes 112C. In the initialization procedure, the microprocessor 112 may load a group of In-System Programming (ISP) codes (not shown in FIG. 1) from the memory device 120. The microprocessor 112 may execute the group of ISP codes, so that the data storage device 100 has various functions. According to an embodiment of the invention, the group of ISP codes may comprise, but are not limited to: one or more program modules related to memory access (e.g., read, write and erase), such as a read operation module, a table lookup module, a wear leveling module, a read refresh module, a read reclaim module, a garbage collection module, a sudden power off recovery (SPOR) module and an uncorrectable error correction code (UECC) module, respectively provided for performing the operations of read, table lookup, wear leveling, read refresh, read reclaim, garbage collection, SPOR and error handling for detected UECC error.

The memory interface 114 may comprise an encoder 132 and a decoder 134. The encoder 132 is configured to encode the data to be written into the memory device 120, such as performing ECC encoding. The decoder 134 is configured decode the data read out from the memory device 120.

Typically, the memory device 120 may comprise a plurality of memory elements, such as a plurality of Flash memory dies or Flash memory chips, and each memory element may comprise a plurality of memory blocks. The access unit of an erase operation performed by the memory controller 110 on the memory device 120 may be one memory block. In addition, a memory block may record (comprise) a predetermined number of pages, for example, the physical pages, and the access unit of a write operation performed by the memory controller 110 on the memory device 120 may be one page.

In practice, the memory controller 110 may perform various control operations by using its own internal components. For example, the memory controller 110 may use the memory interface 114 to control the access operations (especially the access operation for at least a memory block or at least a page) of the memory device 120, use the buffer memory 116 to perform necessary data buffer operations, and use the host interface 118 to communicate with the host device 130.

In an embodiment of the invention, the memory controller 110 may use the host interface 118 to communicate with the host device 130 in compliance with a standard communication protocol. For example, the standard communication protocol may comprise (but is not limited to) the Universal Serial Bus (USB) standard, the SD interface standard, the Ultra High Speed-I (UHS-I) interface standard, the Ultra High Speed-II (UHS-II) interface standard, the CF interface standard, the Multi Media Card (MMC) interface standard, the eMMC interface standard, the UFS interface standard, the Advanced Technology Attachment (ATA) standard, the Serial ATA (SATA) standard, the Peripheral Component Interconnect Express (PCI-E) standard, the Parallel Advanced Technology Attachment (PATA) standard, etc.

In an embodiment, the buffer memory 116 may be implemented by a RAM. For example, the buffer memory 116 may be an SRAM, but the invention should not be limited thereto. In other embodiments, the buffer memory 116 may be a DRAM.

In an embodiment of the invention, the data storage device 100 may be a portable storage device (for example, the memory card in compliance with the SD/MMC, CF, MS and/or XD standard), and the host device 130 may be an electronic device, such as a mobile phone, a notebook computer, a desktop computer . . . etc., capable of connecting to the data storage device. In another embodiment of the invention, the data storage device 100 may be a solid state hard disk or an embedded storage device in compliance with the UFS or the eMMC standards, and may be equipped in an electronic device such as a mobile phone, a notebook computer, or a desktop computer. In such an embodiment, the host device 130 may be a processor of the electronic device.

The host device 130 may issue commands, such as the read command or the write command, to the data storage device 100, so as to access the data stored in the memory device 120, or the host device 130 may issue commands to further control or manage the data storage device 100.

Generally, the memory controller 110 may configure one or more predetermined memory blocks as a cache memory, or called a buffer, or the predetermined memory blocks may also be named as the current blocks or active blocks, to receive data from the host device 130. The configured predetermined memory blocks may be Single-Level Cell (SLC) memory blocks, Multiple-Level Cell (MLC) memory blocks, Triple-Level Cell (TLC) memory blocks, or other types of memory blocks with further more levels. When the usage of the buffer reaches a certain level, the memory controller 110 may write the data stored in the buffer into another memory block (for example, to write the data stored in multiple SLC memory blocks into a TLC memory block), and labeled said another memory block as a data block in the user area or data area of the memory device 120, or, the memory controller 110 may directly update a memory block which has been utilized as the buffer to a data block in the user area or data area. In this manner, the memory space of the buffer can be released and used again in forthcoming operations.

In addition, the host device 130 may determine whether to activate a WriteBooster function at the data storage device 100 side. When the WriteBooster is activated, the memory controller 110 may configure the SLC blocks as the buffer to receive data from the host device 130. Since the speed of writing data in a SLC memory block is faster than the speed of writing data in other types of memory blocks (such as the MLC memory block, TLC memory block, or others), the write operation may be performed in a high-speed mode when using the SLC blocks as the buffer to receive data from the host device 130.

The host device 130 may issue corresponding commands to activate and control the WriteBooster function at the data storage device 100. As an example, the host device 130 may instruct the data storage device 100 to activate the WriteBooster function by issuing a command to set a corresponding flag or by issuing an activate WriteBooster command.

When the WriteBooster function is activated, the host device 130 may further issue a query command to the data storage device 100 to query the buffer size currently configured by the memory controller 110. For example, the host device 130 may query the data storage device 100 about the status of the WriteBooster by reading the corresponding attributes, wherein the attributes may comprise a current WriteBooster buffer size (Current_Write_Booster_Buffer_Size), an available WriteBooster buffer size (Available_Write_Booster_Buffer_Size), or others. Note that the buffer size configured by the memory controller 110 is not a fixed setting and may be dynamically adjusted by the memory controller 110.

As described above, the product developer will perform various write buffer related tests to confirm that the write operation of the data storage device functions normally, and determine whether the data storage device is able to correctly record various parameters related to the write buffer. To correctly record the parameter and to avoid parameter recording error, a method for managing a write buffer to correctly maintain the parameters related to the write buffer so that the parameter recording error does not occur in all test scenarios is required.

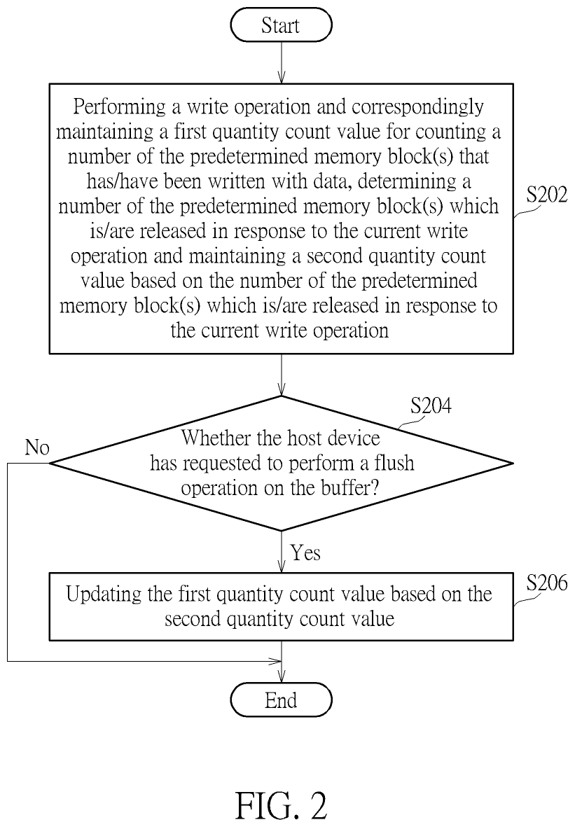

FIG. 2 shows a schematic flow chart of the method for managing a write buffer of a data storage device according to a first embodiment of the invention. The method may be performed by the memory controller 110 and may comprise the following steps:

Step S202: performing a write operation in response to a write command issued by the host device 130. In the write operation, the memory controller may be configured to correspondingly maintain a first quantity count value for counting a number of the predetermined memory block(s) that has/have been written with data among the predetermined memory blocks that are configured as the buffer for receiving data from the host device 130, determine a number of the predetermined memory block(s) which is/are released in response to the current write operation and maintain a second quantity count value based on the number of the predetermined memory block(s) which is/are released in response to the current write operation. In the embodiments of the invention, the first quantity count value is configured to record (count) the number of the predetermined memory block(s) that has/have been written with data among the predetermined memory blocks currently configured as the buffer, and the second quantity count value is configured to record (count) the number of the predetermined memory block(s) that is/are released among the predetermined memory block(s) currently being written with data.

Step S204: determining whether the host device has requested to perform a flush operation on the predetermined memory blocks configured as the buffer after the write operation is completed. In the embodiments of the invention, the flush operation may be the aforementioned operation in which the data stored in multiple SLC memory blocks, which are configured as the buffer, is merged and written into another memory block. In the embodiment of the invention, when the host device has requested to perform the flush operation on the predetermined memory blocks configured as the buffer, the memory controller 110 may perform the aforementioned data merging operation at an appropriate time, and in step S204, when it is determined that the host device has requested to perform the flush operation on the predetermined memory blocks configured as the buffer, step S206 is performed.

Step S206: updating the first quantity count value based on the second quantity count value, for the first quantity count value to reflect the result of one or more memory blocks being released.

On the other hand, when it is determined that the host device 130 has not requested to perform the flush operation on the predetermined memory blocks configured as the buffer, the memory controller 110 is configured not to update the first quantity count value based on the second quantity count value.

According to an embodiment of the invention, the memory controller 110 may update the first quantity count value by subtracting the second quantity count value from the first quantity count value. In addition, the memory controller 110 may be further configured to return an available write buffer size to the host device 130 in response to a query command issued by the host device 130, and the wherein the available write buffer size may be the aforementioned available WriteBooster buffer size (Available_Write_Booster_Buffer_Size), and the memory controller 110 may calculate the available write buffer size based on the first quantity count value.

Since the values of the parameters related to the write buffer are frequently changed with the status change of the write buffer, the method for managing the write buffer is proposed to correctly maintain the parameters related to the write buffer, as an example, the aforementioned first quantity count value, for the first quantity count value to reflect the result of one or more memory blocks being released. In this manner, the available write buffer size calculated based on the first quantity count value may also accurately reflect the current available WriteBooster buffer size (Available_Write_Booster_Buffer_Size).

As discussed above, the host device 130 may issue corresponding commands to control the WriteBooster function at the data storage device 100. According to an embodiment of the invention, the host device 130 may set a status or a value of a predetermined flag by issuing a corresponding command, as an example, by setting the predetermined flag to different values which respectively represent to activate or deactivate the flush operation to flush the data stored in the buffer to the user are or the data area (i.e., the aforementioned merging operation in which the data stored in multiple SLC memory blocks, which are configured as the buffer, is merged and written into another memory block). Therefore, according to an embodiment of the invention, the memory controller 110 may determine whether the host device 130 has requested to perform the flush operation on the predetermined memory blocks according to a setting value of the predetermined flag.

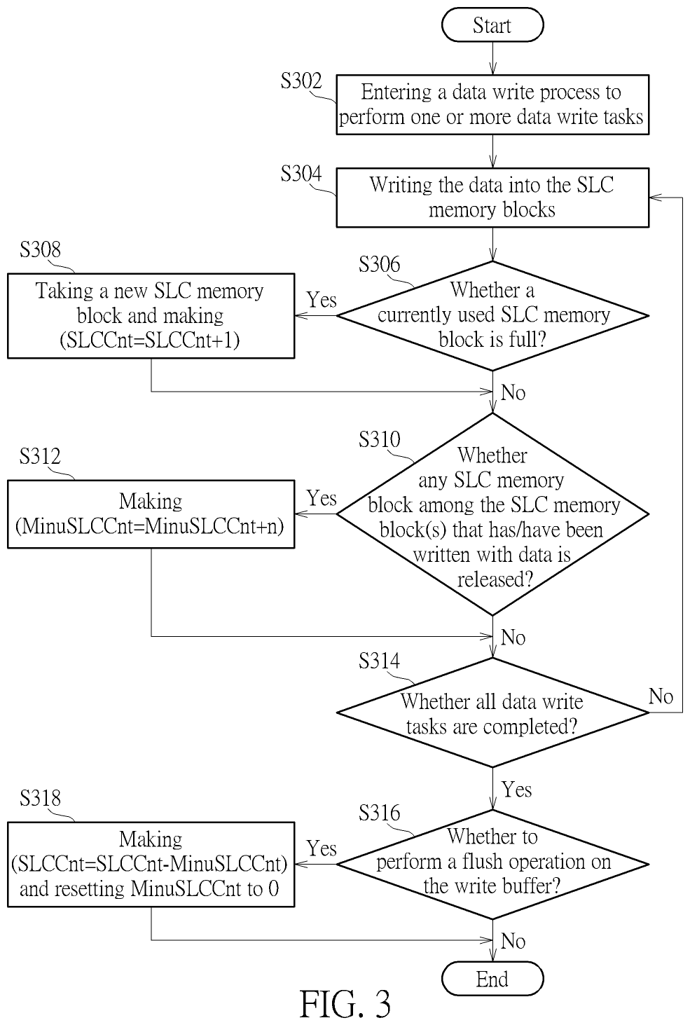

FIG. 3 shows a detailed flow chart of the method for managing a write buffer of a data storage device according to the first embodiment of the invention. In the exemplary flow chart shown in FIG. 3, the WriteBooster function is activated and therefore, the predetermined memory blocks configured as the buffer are the SLC memory blocks, and proposed method for determining buffer size in the first embodiment of the invention may be performed by the memory controller 110 in response to the reception of the write command issued by the host device 130 and may comprise the following steps:

Step S302: entering a data write process to perform one or more data write tasks in response to a write command.

Step S304: writing the data into the SLC memory blocks configured as the buffer.

Step S306: determining whether a currently used SLC memory block is full. If the determination result shows yes, step S308 is performed. If the determination result shows no, step S310 is performed.

Step S308: taking a new SLC memory block (as an example, taking a spare memory block and perform an erase operation to erase the memory block in a corresponding manner so as to configure the memory block as a SLC memory block), and updating the quantity count value (e.g., the aforementioned first quantity count value) SLCCnt. As an example, the SLCCnt may be added by 1. When being expressed in a formula, the calculation is expressed as SLCCnt=SLCCnt+1. In the embodiments of the invention, the quantity count value SLCCnt records (counts) the number of SLC memory block(s) that has/have been written with data.

If the currently used SLC memory block is full but there is still some data of the current data write task not been written in the memory device, step S308 may further comprise the operations of writing the remaining data related to the current data write task into the newly configured SLC memory block.

Step S310: determining whether any SLC memory block that has been written with data is released (or, can be or will be released). If the determination shows yes, step S312 is performed. If the determination shows no, step S314 is performed.

According to an embodiment of the invention, the memory controller 110 may determine whether an SLC memory block that has been written with data and is released (or, can be or will be released) according to whether the valid data size of this memory block is zero. To be more specific, the memory controller 110 may record another quantity count value, such as a valid page count, for each memory block to record the number of valid pages with respect to the corresponding memory block. When the valid page count of a memory block is zero, it means that all the data stored therein is invalid data. Therefore, the memory controller 110 may release this memory block.

Generally, the data stored in a physical memory block has a corresponding logical address, for example, Logical Block Address (LBA), wherein the LBA is the address utilized at the host device 130 side to identify the logical storage space. When the memory controller 110 receives data corresponding to a logical address in a write command, the memory controller 110 determines whether data corresponding to this logical address has already been stored in the memory device 120 (e.g., by inspecting contents of the mapping tables maintained by the memory controller 110 to determine whether this logical address has been recorded in any physical-to-logical mapping table maintained by the memory controller 110). If the determination result shows yes, it means that the host device 130 has updated the data corresponding to this logical address. Therefore, the data that has previously been written into the memory device 120 corresponding to this logical address will be marked as invalid data, and the valid page count corresponding to the memory block storing the data that becomes invalid is correspondingly adjusted, for example, is decreased. In addition, when the data stored in a memory block becomes invalid due to data deletion initiated by the user or other operations, the valid page count corresponding to the memory block will be adjusted accordingly. Therefore, the memory controller 110 may determine whether the memory block can be released by determining whether the valid page count of a memory block is zero.

In an embodiment of the invention, the memory controller 110 may check the valid page count of the SLC memory blocks that have been written with data one by one in step S310 to determine whether there is any memory block released (or, can be or will be released) in response to the current write operation, and record the number of memory blocks that can be released in response to the current write operation.

Step S312: (assuming that in step S310, n memory blocks are determined to be released) maintaining another quantity count value (e.g., the second quantity count value) MinuSLCCnt according to the number. When being expressed in a formula, the calculation is expressed as MinuSLCCnt=MinuSLCCnt+n.

Step S314: determining whether all data write tasks are completed. If the determination result shows yes, step S316 is performed. If the determination result shows no, step S304 is returned to perform the next data write task to write data into the SLC memory block.

Step S316: determining whether to perform a flush operation on the write buffer. If the determination result shows yes, step S318 is performed. If the determination shows no, the memory controller 110 may end the flow. As described above, the memory controller 110 may determine whether the host device 130 has requested to perform the flush operation on the predetermined memory blocks (i.e., the write buffer) according to a setting value of the predetermined flag.

Step S318: subtracting the quantity count value MinuSLCCnt from the quantity count value SLCCnt (when being expressed in a formula, the calculation is expressed as SLCCnt=SLCCnt-MinuSLCCnt), and resetting the quantity count value MinuSLCCnt to 0.

On the other hand, when it is determined that there is no need to perform a flush operation on the write buffer, the quantity count values SLCCnt and MinuSLCCnt are not modified.

As described above, the memory controller 110 may determine whether there is a need to perform a flush operation on the write buffer according to a setting value of the predetermined flag. In addition, as described above, the proposed method for managing the write buffer may further comprise an operation of returning the available write buffer size to the host device 130 in response to a query command issued by the host device, and the wherein the available write buffer size may be the aforementioned available WriteBooster buffer size (Available_Write_Booster_Buffer_Size), and the memory controller 110 may calculate the available write buffer size based on the quantity count value SLCCnt. As an example, subtracting the quantity count value SLCCnt from the current WriteBooster buffer size (Current_Write_Booster_Buffer_Size) to obtain the available WriteBooster buffer size (Available_Write_Booster_Buffer_Size).

By implementing the proposed method for managing the write buffer, the parameters related to the write buffer, such as the quantity count value SLCCnt, are correctly recorded so as to avoid the parameter recording error as well as to ensure that the host device 130 receives the correct parameter values, for example, the available WriteBooster buffer size (Available_Write_Booster_Buffer_Size).

In the second embodiment of the invention, since the flush operation performed on the write buffer may be integrated in the Garbage Collection (GC) operation, the memory controller 110 may also integrate the operations of updating the quantity count values related to the write buffer in the flow of a GC operation.

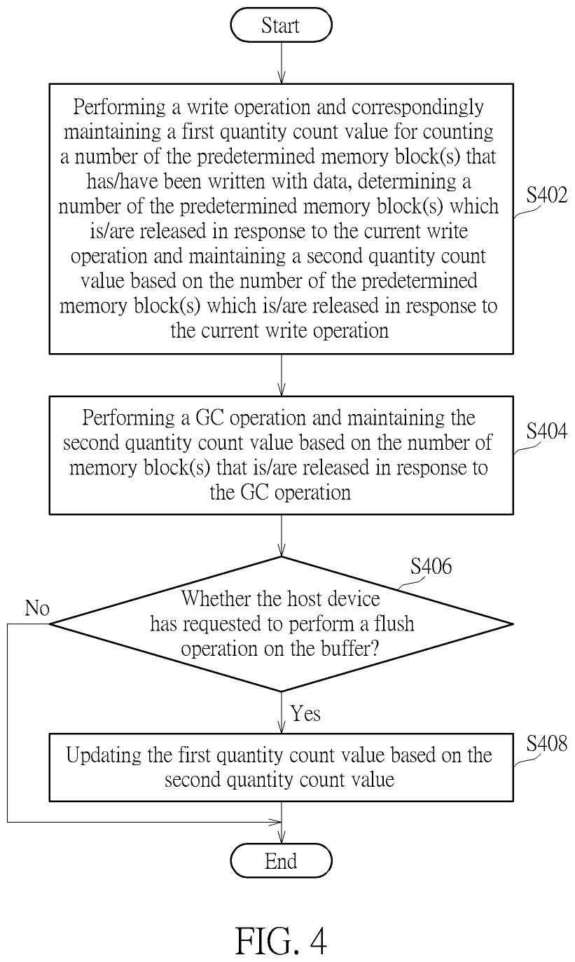

FIG. 4 shows a schematic flow chart of the method for managing a write buffer of a data storage device according to a second embodiment of the invention. The method may be performed by the memory controller 110 and may comprise the following steps:

Step S402: performing a write operation in response to a write command issued by the host device 130. In the write operation, the memory controller may be configured to correspondingly maintain a first quantity count value for counting a number of the predetermined memory block(s) that has/have been written with data among the predetermined memory blocks that are configured as the buffer for receiving data from the host device 130, determine a number of the predetermined memory block(s) which is/are released in response to the current write operation and maintain a second quantity count value based on the number of the predetermined memory block(s) which is/are released in response to the current write operation. In the embodiments of the invention, the first quantity count value is configured to record (count) the number of the predetermined memory block(s) that has/have been written with data among the predetermined memory blocks currently configured as the buffer, and the second quantity count value is configured to record (count) the number of the predetermined memory block(s) that is/are released among the predetermined memory block(s) currently being written with data.

Step S404: performing a garbage collection operation after the write operation is completed to collect the valid data randomly distributed in different memory blocks and write the collected valid data into a new memory block. According to an embodiment of the invention, during the garbage collection operation, the memory controller 110 may also determine a number of memory block(s) (e.g., a number of the predetermined memory block(s), but the invention is not limited thereto) that is/are released in response to the GC operation, and maintain the second quantity count value based on the number of memory block(s) that is/are released in response to the GC operation.

Step S406: determining whether the host device has requested to perform a flush operation on the predetermined memory blocks configured as the buffer after the GC operation is completed. In the embodiments of the invention, the flush operation may be the aforementioned operation in which the data stored in multiple SLC memory blocks is merged and written into another memory block. In the embodiment of the invention, when it is determined that the host device 130 has requested to perform the flush operation on the predetermined memory blocks configured as the buffer, step S408 is performed. When it is determined that the host device 130 has not requested to perform the flush operation on the predetermined memory blocks configured as the buffer, the memory controller 110 may end the flow.

Step S408: performing the flush operation on the predetermined memory blocks and updating the first quantity count value based on the second quantity count value, for the first quantity count value to reflect the result of one or more memory blocks being released.

It is to be noted that since the flush operation of the write buffer may also be integrated in the GC operation, that is, during the process of collection the valid data, the memory controller 110 may also collect the valid data stored in the predetermined memory blocks configured as the buffer. Therefore, in some embodiments of the invention, performance of the GC operation in step S404 may also comprise the performance of the flush operation (when the host device 130 has requested to perform the flush operation on the predetermined memory blocks), and in such embodiments, step s408 may only comprise the operation of updating the first quantity count value based on the second quantity count value.

On the other hand, when it is determined that the host device has not requested to perform the flush operation on the predetermined memory blocks configured as the buffer, the memory controller 110 is configured not to update the first quantity count value based on the second quantity count value.

As described above, the memory controller 110 may update the first quantity count value by subtracting the second quantity count value from the first quantity count value. In addition, the memory controller 110 may be further configured to return an available write buffer size to the host device 130 in response to a query command issued by the host device 130, and the wherein the available write buffer size may be the aforementioned available WriteBooster buffer size (Available_Write_Booster_Buffer_Size), and the memory controller 110 may calculate the available write buffer size based on the first quantity count value.

Since the values of the parameters related to the write buffer are frequently changed with the status change of the write buffer, the method for managing the write buffer is proposed to correctly maintain the parameters related to the write buffer, as an example, the aforementioned first quantity count value, for the first quantity count value to reflect the result of one or more memory blocks being released. In this manner, the available write buffer size calculated based on the first quantity count value may also accurately reflect the current available WriteBooster buffer size (Available_Write_Booster_Buffer_Size).

In addition, as discussed above, the host device 130 may issue corresponding commands to control the WriteBooster function at the data storage device 100. According to an embodiment of the invention, the host device 130 may set a status or a value of a predetermined flag by issuing a corresponding command, as an example, by setting the predetermined flag to different values which respectively represent to activate or deactivate the flush operation to flush the data stored in the buffer to the user are or the data area (i.e., the aforementioned merging operation in which the data stored in multiple SLC memory blocks is merged and written into another memory block). Therefore, according to an embodiment of the invention, the memory controller 110 may determine whether the host device 130 has requested to perform the flush operation on the predetermined memory blocks according to a setting value of the predetermined flag.

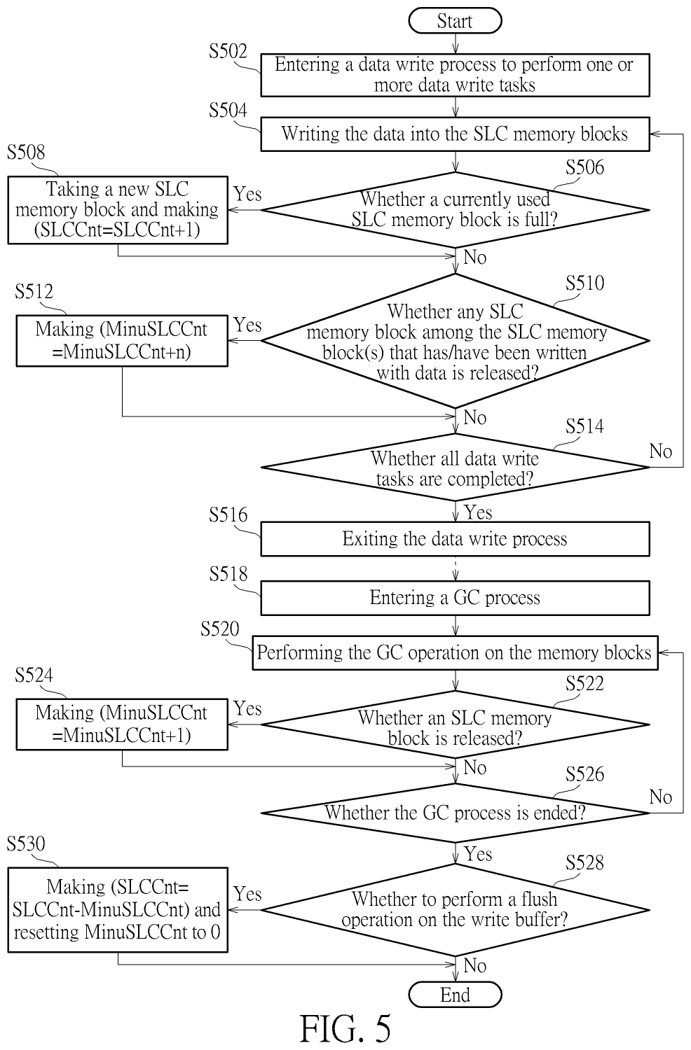

FIG. 5 shows a detailed flow chart of the method for managing a write buffer of a data storage device according to the second embodiment of the invention. In the exemplary flow chart shown in FIG. 5, the WriteBooster function is activated and therefore, the predetermined memory blocks configured as the buffer are the SLC memory blocks, and proposed method for determining buffer size in the second embodiment of the invention may be performed by the memory controller 110 in response to the reception of the write command issued by the host device 130 and may comprise the following steps:

Step S502: entering a data write process to perform one or more data write tasks in response to a write command.

Step S504: writing the data into the SLC memory blocks configured as the buffer.

Step S506: determining whether a currently used SLC memory block is full. If the determination result shows yes, step S508 is performed. If the determination result shows no, step S510 is performed.

Step S508: taking a new SLC memory block (as an example, taking a spare memory block and perform an erase operation to erase the memory block in a corresponding manner so as to configure the memory block as a SLC memory block), and updating the quantity count value (e.g., the aforementioned first quantity count value) SLCCnt. As an example, the SLCCnt may be added by 1. When being expressed in a formula, the calculation is expressed as SLCCnt=SLCCnt+1. In the embodiments of the invention, the quantity count value SLCCnt records (counts) the number of SLC memory block(s) that has/have been written with data.

If the currently used SLC memory block is full but there is still some data of the current data write task not been written in the memory device, step S508 may further comprise the operations of writing the remaining data related to the current data write task into the newly configured SLC memory block.

Step S510: determining whether any SLC memory block that has been written with data is released (or, can be or will be released). If the determination shows yes, step S512 is performed. If the determination shows no, step S514 is performed.

Similarly, the memory controller 110 may determine whether an SLC memory block that has been written with data and is released (or, can be or will be released) according to whether the valid data size of this memory block is zero. As an example, the memory controller 110 may determine whether a memory block can be released by determining whether the valid page count of the memory block is zero. In an embodiment of the invention, the memory controller 110 may check the valid page count of the SLC memory blocks that have been written with data one by one in step S510 to determine whether there is any memory block released (or, can be or will be released) in response to the current write operation, and record the number of memory blocks that can be released in response to the current write operation.

Step S512: (assuming that in step S510, n memory blocks are determined to be released) maintaining another quantity count value (e.g., the second quantity count value) MinuSLCCnt according to the number. When being expressed in a formula, the calculation is expressed as MinuSLCCnt=MinuSLCCnt+n.

Step S514: determining whether all data write tasks are completed. If the determination result shows yes, step S516 is performed. If the determination result shows no, step S504 is returned to perform the next data write task to write data into the SLC memory block.

Step S516: exiting the data write process.

According to an embodiment of the invention, after exiting the data write process, the memory controller 110 may perform step S518 an appropriate time, as an example, when determining that the data storage device 100 is idle. In an embodiment of the invention, the memory controller 110 may observe a predetermined time and determine whether there is any command received from the host device 130 within the predetermined time. If no command is received from the host device 130 within the predetermined time, the memory controller 110 may determine that the data storage device 100 is idle, and start to perform step S518.

Step S518: entering a GC process.

Step S520: performing the GC operation on the memory blocks (such as the SLC memory blocks).

Step S522: determining whether an SLC memory block that has been written with data is released (or, can be or will be released). As described above, the memory controller 110 may determine whether a current SLC memory block is released in response to the current GC operation by determining whether the valid page count of this SLC memory block is decreased to zero due to the current GC operation. If the determination shows yes, step S524 is performed. If the determination shows no, step S526 is performed.

Step S524: updating the quantity count value MinuSLCCnt in response to the release of the memory block. When being expressed in a formula, the calculation is expressed as MinuSLCCnt=MinuSLCCnt+1.

Step S526: determining whether the GC process is ended. If the determination shows yes, step S528 is performed. If the determination shows no, step S520 is returned to continue the GC operation.

Step S528: determining whether to perform a flush operation on the write buffer. If the determination result shows yes, step S530 is performed. If the determination shows no, the memory controller 110 may end the flow. As described above, the memory controller 110 may determine whether the host device 130 has requested to perform the flush operation on the predetermined memory blocks (i.e., the write buffer) according to a setting value of the predetermined flag.

Step S530: subtracting the quantity count value MinuSLCCnt from the quantity count value SLCCnt (when being expressed in a formula, the calculation is expressed as SLCCnt=SLCCnt-MinuSLCCnt), and resetting the quantity count value MinuSLCCnt to 0.

On the other hand, when it is determined that there is no need to perform a flush operation on the write buffer, the quantity count values SLCCnt and MinuSLCCnt are not modified.

As described above, the memory controller 110 may determine whether there is a need to perform a flush operation on the write buffer according to a setting value of the predetermined flag. In addition, as described above, the proposed method for managing the write buffer may further comprise an operation of returning the available write buffer size to the host device 130 in response to a query command issued by the host device, and the wherein the available write buffer size may be the aforementioned available WriteBooster buffer size (Available_Write_Booster_Buffer_Size), and the memory controller 110 may calculate the available write buffer size based on the quantity count value SLCCnt. As an example, subtracting the quantity count value SLCCnt from the current WriteBooster buffer size (Current_Write_Booster_Buffer_Size) to obtain the available WriteBooster buffer size (Available_Write_Booster_Buffer_Size).

By implementing the proposed method for managing the write buffer, the parameters related to the write buffer, such as the quantity count value SLCCnt, are correctly recorded so as to avoid the parameter recording error as well as to ensure that the host device 130 receives the correct parameter values, for example, the available WriteBooster buffer size (Available_Write_Booster_Buffer_Size).

Especially, when the host device 130 repeatedly writes data corresponding to the same logical address, the old data will be marked as invalid data in response to update of the data, which speeds up the release of memory blocks. By implementing the proposed method for managing the write buffer, if the host device 130 has not requested to perform the flush operation on the predetermined memory blocks, the result of one or more memory blocks being released is temporarily not reflected in the quantity count value SLCCnt. On the contrary, when the host device 130 has requested to perform the flush operation on the predetermined memory blocks, no matter whether the flush operation has already been performed, the result of one or more memory blocks being released is reflected at an appropriate time, as described in the first and second embodiments. In this manner, the available write buffer size calculated by the memory controller 110 based on the quantity count value SLCCnt accurately reflect the current available WriteBooster buffer size, to ensure that the host device 130 receives the correct parameter values, and the problem that the available write buffer size received by the host device 130 is not correspondingly decreased in response to the write operation when the host device 130 keeps writing data corresponding to the same logical address to the data storage device 100 is solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data storage device, comprising:
a memory device, comprising a plurality of memory blocks, wherein the memory blocks comprise a plurality of predetermined memory blocks that are configured as a buffer for receiving data from a host device; and
a memory controller, coupled to the memory device and configured to access the memory device, wherein the memory controller is configured to perform a write operation in response to a write command issued by the host device, and in the write operation, the memory controller is configured to maintain a first quantity count value for counting a number of the predetermined memory block(s) that has/have been written with data, determine a number of the predetermined memory block(s) which is/are released in response to the write operation and maintain a second quantity count value based on the number of the predetermined memory block(s) which is/are released in response to the write operation, and
after the write operation is completed, the memory controller is further configured to perform a garbage collection operation and determine whether the host device has requested to perform a flush operation on the predetermined memory blocks,
wherein when determining that the host device has requested to perform the flush operation on the predetermined memory blocks, the memory controller is further configured to update the first quantity count value based on the second quantity count value.

2. The data storage device of claim 1, wherein in the garbage collection operation, the memory controller is further configured to determine a number of the memory block(s) which is/are released in response to the garbage collection operation and maintain the second quantity count value based on the number of the memory block(s) which is/are released in response to the garbage collection operation.

3. The data storage device of claim 1, wherein when determining that the host device has not requested to perform the flush operation on the predetermined memory blocks, the memory controller does not update the first quantity count value based on the second quantity count value.

4. The data storage device of claim 1, wherein the memory controller updates the first quantity count value by subtracting the second quantity count value from the first quantity count value.

5. The data storage device of claim 1, wherein the memory controller is further configured to return an available write buffer size to the host device in response to a query command issued by the host device, and the wherein the available write buffer size is calculated based on the first quantity count value.

6. The data storage device of claim 1, wherein the memory controller is configured to determine whether the host device has requested to perform the flush operation on the predetermined memory blocks according to a setting value of a predetermined flag.

7. The data storage device of claim 1, wherein the memory controller determines the number of the predetermined memory block block(s) which is/are released in response to the write operation according to a number of the predetermined memory block(s) whose valid data size is zero among the predetermined memory block(s) that has/have been written with data.

8. A method for managing a write buffer of a data storage device which comprises a memory device and a memory controller, the memory device comprises a plurality of memory blocks, the memory blocks comprises a plurality of predetermined memory blocks that are configured as a buffer for receiving data from a host device, and the method comprises:
performing a write operation in response to a write command issued by the host device,
wherein step of performing the write operation in response to the write command issued by the host device further comprises:
maintaining a first quantity count value for counting a number of the predetermined memory block(s) that has/have been written with data;
determining a number of the predetermined memory block(s) which is/are released in response to the write operation; and
maintaining a second quantity count value based on the number of the predetermined memory block(s) which is/are released in response to the write operation,
performing a garbage collection operation;
determining whether the host device has requested to perform a flush operation on the predetermined memory blocks; and
updating the first quantity count value based on the second quantity count value when determining that the host device has requested to perform the flush operation on the predetermined memory blocks.

9. The method of claim 8, where step of performing the garbage collection operation further comprises:
determining a number of the memory block(s) which is/are released in response to the garbage collection operation; and
maintaining the second quantity count value based on the number of the memory block(s) which is/are released in response to the garbage collection operation.

10. The method of claim 8, further comprising:
not updating the first quantity count value based on the second quantity count value when determining that the host device has not requested to perform the flush operation on the predetermined memory blocks.

11. The method of claim 8, wherein operation of updating the first quantity count value based on the second quantity count value further comprises:
subtracting the second quantity count value from the first quantity count value.

12. The method of claim 8, further comprising:
calculating an available write buffer size based on the first quantity count value; and
returning the available write buffer size to the host device in response to a query command issued by the host device.

13. The method of claim 8, wherein whether the host device has requested to perform the flush operation on the predetermined memory blocks is determined according to a setting value of a predetermined flag.

14. The method of claim 8, wherein the number of the predetermined memory block block(s) which is/are released in response to the write operation is determined according to a number of the predetermined memory block(s) whose valid data size is zero among the predetermined memory block(s) that has/have been written with data.
